(19) United States
(12) Patent Application Publication
(10) Pub. No.: US 2006/0114374 A1
(43) Pub. Date: Jun. 1, 2006

(54) Liquid crystal display device

(76) Inventors: Yasuo Segawa, Motosu-gun (JP); Masaaki Aota, Ogaki (JP)

Correspondence Address: CANTOR COLBURN, LLP, 55 GRIFFIN ROAD SOUTH, BLOOMFIELD, CT, 06002, US

(21) Appl. No.: 11/290,851

(22) Filed: Nov. 30, 2005

(30) Foreign Application Priority Data
Nov. 30, 2004 (JP) 2004-345218
Nov. 22, 2005 (JP) 2005-337877

(51) Int. Cl. G02F 1/1335

(52) U.S. Cl. 349/95

(57) ABSTRACT

Liquid crystal is sealed between two substrates. On the viewing side substrate, a lens structure is provided in positions corresponding to the display regions capable of display in the respective pixels or the light-shielding regions. By enlarging and displaying the display regions, or by reducing and displaying the light-shielding regions surrounding the pixels, the light-shielding regions are displayed in relatively reduced sizes, thereby minimizing roughness in displayed images.

### CROSS-REFERENCE TO RELATED APPLICATIONS

The priority Japanese application Nos. 2004-345218 and 2005-337877 upon which this patent application is based are hereby incorporated by reference.

### BACKGROUND OF THE INVENTION

1. Field of the Invention

The present invention relates to a structure of a liquid crystal display device.

2. Description of the Related Art

In a liquid crystal display device, liquid crystal is sealed between two substrates, and electrodes are provided on the liquid crystal sides of the respective two substrates. In this display device, display is performed by controlling the alignment state of the liquid crystal by means of an electric field generated by the electrodes, so as to control the amount of light emitted outside from the liquid crystal cell composed of the substrates and the liquid crystal. The liquid crystal cell includes a plurality of pixels. For example, in an active matrix type liquid crystal display device, individual pixel electrodes for the respective pixels are provided on one of the substrates, and a common electrode is formed on the other substrate. Voltages applied to the respective pixel electrodes are controlled individually, so as to achieve display separately in each pixel. One pixel is configured in a region where the electrodes formed on the pair of substrates are positioned opposing one another on both sides of the liquid crystal. In an active matrix type liquid crystal display device, a display region (a region from which light can be emitted, or a region capable of performing display) within each pixel is nearly equivalent to the formation region of the pixel electrode. However, when portions of the formation region of a pixel electrode are overlapped by a light-shielding pixel component, a switch element, or the like, the overlapped portions become non-display regions. At the gap between adjacent pixels, a light-shielding region is formed using a light-shielding layer called black matrix (BM), in order to prevent light leakage which may occur between the adjacent pixels. In the case of an active matrix type liquid crystal display device, the switching elements and wiring for supplying signals to pixels are formed in the light-shielding region.

Typically, when attempting to reduce the area of the formation regions of wirings and switch elements which become non-light-emitting regions, there are limitations because a certain level of performance of the wiring and switch elements must be ensured. Further, also in respect of prevention of light leakage from between adjacent pixels, the light-shielding region (non-display region) between adjacent pixels cannot be made narrower than a certain width.

Accordingly, in a small-sized liquid crystal display device (having a small panel area), the relative area of non-display region per pixel becomes larger. In other words, the proportion of the gaps between adjacent pixels with respect to the display regions becomes greater, such that the non-display regions become more noticeable, resulting in visual roughness in the displayed image. In particular, in cases in which liquid crystal display devices are employed as an electronic viewfinder (EVF) of a video camera or the like and a projector, because a display image of a small-sized liquid crystal panel is enlarged by means of a lens system when being observed, the light-shielding region is enlarged together with the display regions. As a result, the presence of the light-shielding region becomes highly noticeable, causing degradation in image quality.

### SUMMARY OF THE INVENTION

The present invention serves to reduce adverse effects of the light-shielding region on image quality.

In a liquid crystal display device according to the present invention, a lens structure is provided on the viewing substrate side in a position corresponding to each pixel or a group of pixels. Using this lens structure, the display region of the pixel or pixels is displayed while being enlarged.

With this arrangement, it is possible to make the light-shielding region surrounding the display region appear relatively smaller.

In a liquid crystal display device according to another aspect of the present invention, a lens structure is provided on the viewing substrate side in a position corresponding to a light-shielding region provided covering a gap between adjacent pixels. Using this lens structure, the light-shielding region is displayed while being reduced in size.

According to the present invention, the light-shielding region can be made relatively less noticeable by means of the lens structures as described above, making it possible to reduce roughness in displayed images.

### BRIEF DESCRIPTION OF THE DRAWINGS

FIG. 1 is a cross-sectional view showing a basic structure of a liquid crystal display device.

FIG. 2 is a plan view showing a pattern of a light-shielding region.

FIG. 3 is a plan view showing a lens structure according to an embodiment of the present invention.

FIG. 4 is a cross-sectional view of the lens structure of FIG. 3.

FIG. 5 is a diagram showing a manner in which display is achieved by the liquid crystal display device including the lens structure.

FIG. 6 is a cross-sectional view showing a lens structure according to another embodiment of the present invention.

FIG. 7 is a plan view showing a lens structure according to a further embodiment of the present invention.

FIG. 8 is a diagram showing an example cross-sectional view of the lens structure of FIG. 7.

FIG. 9 is a plan view showing a lens structure according to a still further embodiment of the present invention.

FIG. 10 is a plan view showing a lens structure according to another embodiment of the present invention.

FIG. 11 is a diagram showing an example pattern of pixels and light-shielding region in a delta arrangement.

FIG. 12 is a plan view showing a lens structure employed for the pixel pattern in the delta arrangement.

FIGS. 13A, 13B, 13C, and 13D are diagrams illustrating an example manufacturing method of the lens structure.

### DESCRIPTION OF THE PREFERRED EMBODIMENTS

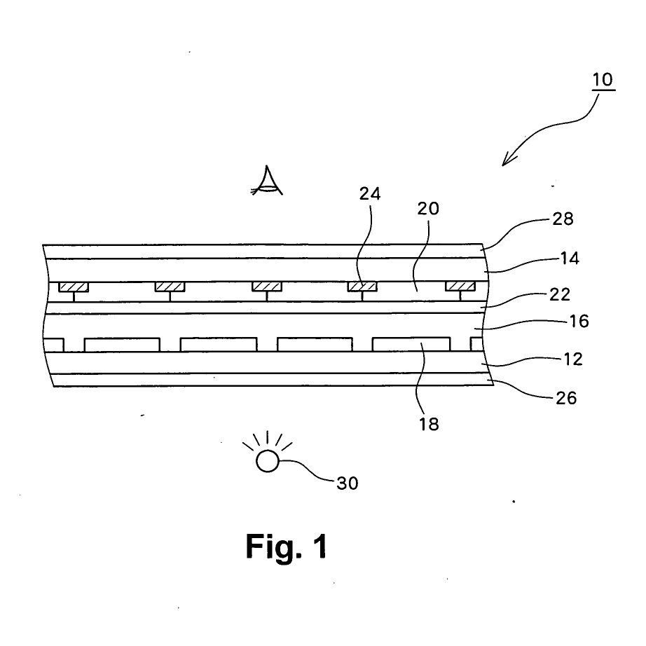

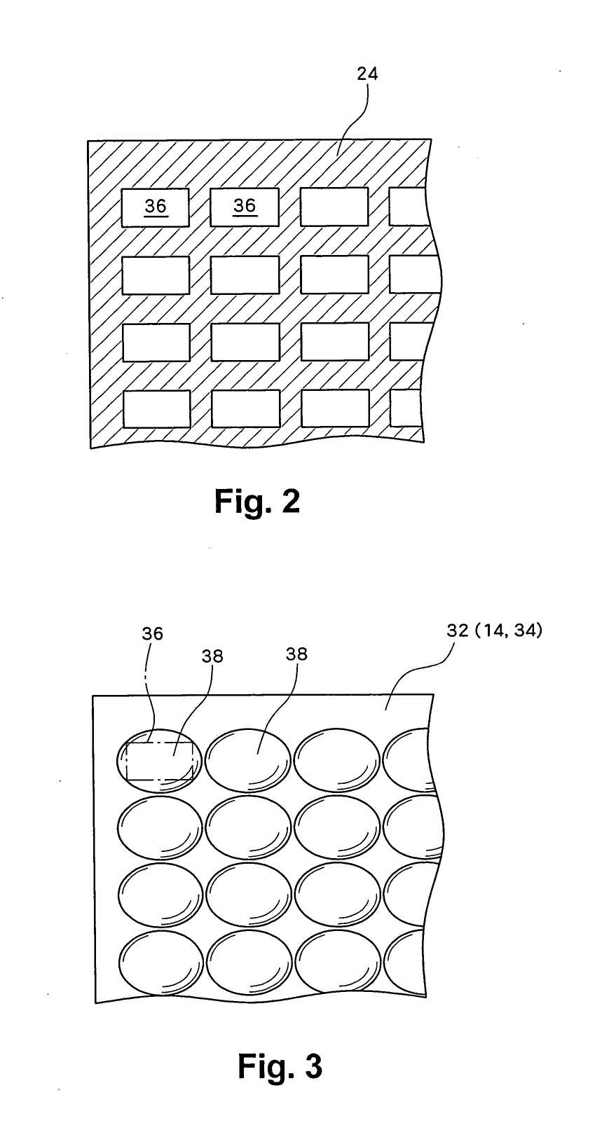

Preferred embodiments of the present invention will next be described referring to the drawings. FIG. 1 is a diagram which schematically depicts a panel structure of a liquid crystal display device (hereinafter simply referred to as “LCD”) 10. An LCD 10 is a display device in which liquid crystal is used as the display element in each pixel. The LCD 10 is configured by sealing liquid crystal between two transparent substrates 12, 14 composed of a material such as glass, so as to form a liquid crystal layer 16. In FIG. 1, the lower substrate is referred to as the first substrate 12, and the upper substrate is referred to as the second substrate 14. When the LCD is an active matrix type LCD, on the liquid crystal layer 16 side of the first substrate 12, individual transparent pixel electrodes 18 are provided for the respective pixels, and a pixel transistor (not shown) and the like are connected to each pixel electrode 18. On the liquid crystal side of the second substrate 14, color filters 20 for each of red, green, or blue, for example, are formed, and a transparent common electrode 22 is disposed covering the color filters 20. Each color filter 20 is arranged at a position opposing a pixel electrode 18, such that a region corresponding to the formation region of each pixel electrode 18 is nearly equivalent to the display region in each pixel. Further, a light-shielding layer 24 is formed on the second substrate 14 at boundary regions of the respective pixels. More specifically, the light-shielding layer 24 is arranged in regions corresponding to gaps between adjacent pixel electrodes 18, that is, in the boundary portions between the color filters 20 formed for the respective pixels. In the overall LCD panel, the light-shielding layer 24 is formed to have a grid pattern as shown in FIG. 2. On the outer sides of the respective two substrates 12, 14, linear polarization plates 26 and 28 are arranged such that their polarization axes are orthogonal to one another. Although not shown, on the surfaces of the substrates 12, 14 which are in contact with the liquid crystal, alignment films are formed covering the pixel electrodes 18 and the common electrode 22, respectively. Further, as described later in detail, according to the present embodiment, on the surface of either one of the first and second substrates 12, 14 which serve as the substrate on the viewing side (in FIG. 1, the second substrate 14), a lens structure is provided which enlarges and displays the displayable regions of the display portion composed of a plurality of pixels arranged in a matrix, and which, in contrast, reduces and displays the light-shielding regions (non-display regions).

When vertically aligned type liquid crystal having negative dielectric constant anisotropy is employed in the liquid crystal layer 16, the long axes (major axes) of the liquid crystal molecules align along the direction perpendicular to the plane of the substrates (parallel to the direction normal to the plane) when no voltage is applied between the electrodes 18, 22. As the voltage applied between the electrodes is increased, the long axes of the liquid crystal molecules become more and more tilted downward so as to align along the direction parallel to the substrate plane. In a state of no voltage application, the liquid crystal is vertically aligned, such that light passing through the liquid crystal layer 16 in this state is not subjected to birefringence. Accordingly, light which is introduced from the light source 30 and linearly polarized by passing though the first polarization plate 26 reaches the second linear polarization plate 28 in that polarized state without being subjected to birefringence by the liquid crystal layer 16. At this point, because the polarization axis of the second linear polarization plate 28 is orthogonal to the polarization axis of the reaching light, this light cannot pass through the second linear polarization plate 28. As a result, the pixel displays the minimum brightness or “black”.

When a voltage is applied between the electrodes 18 and 22, the alignment of the liquid crystal is tilted from the direction normal to the substrates in accordance with the applied voltage. While in this state, a linearly polarized light entering into the liquid crystal layer 16 via the first linear polarization plate 26 is subjected to birefringence by the liquid crystal layer 16. As the light proceeds through the liquid crystal layer 16, the linearly polarized light is changed into elliptically polarized light, subsequently into circularly polarized light, then into elliptically polarized light having a long axis direction which is shifted by 90° from that of the above-noted initial elliptically polarized light, and finally into linearly polarized light. The thickness of the liquid crystal layer 16 is determined and configured such that, when the liquid crystal molecules are completely tilted (that is, when the long axes of the liquid crystal molecules are aligned parallel to the substrate plane), linearly polarized light having a polarization plane orthogonal to that of the initially entering light is emitted from the liquid crystal layer. This emitted linearly polarized light can transmit through the second linear polarization plate 28. As a result, the pixel displays the maximum brightness (white). The light emitted outside via the color filter 20 has a color according to that color filter. When the alignment of the liquid crystal is tilted to an intermediate degree, light passing through the liquid crystal layer 16 is changed into elliptically or circularly polarized light, and only the polarization axis component corresponding to the polarization axis of the second linear polarization plate 28 can transmit through the second linear polarization plate 28. As a result, the pixel displays an intermediate brightness.

Twist nematic (TN) liquid crystal may alternatively be employed in the liquid crystal layer 16. When TN liquid crystal is used, on each of the substrates located on both sides of the liquid crystal, an alignment film which has been subjected to a rubbing treatment is provided on the side which contacts the liquid crystal. In a state in which no voltage is applied between the electrodes, the TN liquid crystal having positive dielectric constant anisotropy is initially aligned such that the long axes of the liquid crystal molecules are positioned along the rubbing directions of the alignment films. The rubbing directions of the alignment films are arranged orthogonal to one another, such that the liquid crystal molecules align while being twisted between the substrates. In other words, the liquid crystal molecules located near one substrate align such that their long axes are oriented along the rubbing direction of that substrate, and as the distance from that substrate increases, the long axes of the liquid crystal molecules are oriented with a twist so as to start aligning along the rubbing direction of the other substrate. When a voltage is applied between the electrodes, the liquid crystal molecules are placed in an upright position along the direction normal to the substrate, such that the twisted alignment state is removed.

When no voltage is applied between the electrodes, linearly polarized light which is introduced into the liquid crystal layer is changed by the liquid crystal molecules in the twisted alignment state, such that the polarization plane of the linearly polarized light becomes twisted by 90°. The resulting light therefore passes through the polarization plate provided on the emitting side. As a result, the pixel displays the maximum brightness. In contrast, when a voltage is applied between the electrodes to thereby completely remove the twisted alignment of the liquid crystal molecules, the polarization plane of the incident linearly polarized light is not influenced by the liquid crystal layer, such that the light does not transmit through the polarization plate provided on the emitting side. As a result, the pixel displays the minimum brightness. By controlling the applied voltage, it is possible to adjust the twist angle of the polarization plane of the incident light, to thereby achieve display of intermediate brightness.

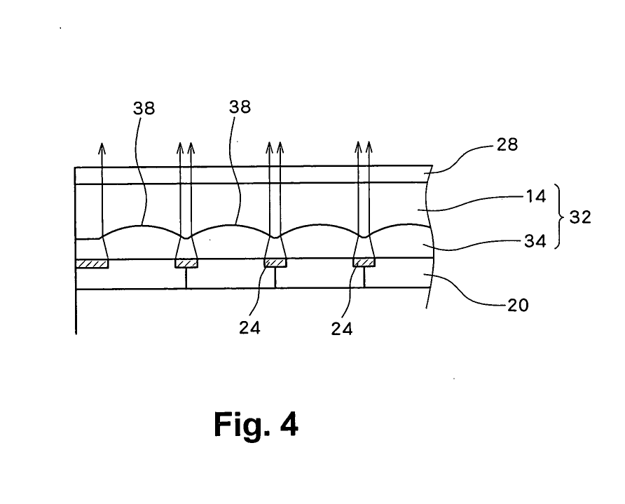

The lens structure is next described. FIGS. 3 and 4 show the substrate on the viewing side (in this example, the second substrate 14) and the lens structure provided adjacent to the viewing side substrate. The lens structure 32 includes the second substrate 14 composed of glass, and a lens member 34 composed of a transparent material having a refraction index greater than that of glass, which may for example be an acrylic organic material. More specifically, concave portions are formed by etching on the liquid crystal side surface of the second substrate. On this surface of the second substrate 14, the lens member 34 having a planar surface on the liquid crystal side is arranged filling in the concave portions. The light-shielding layer 24 and the color filters 20 of the respective colors are formed covering over the lens member 34 having the planar surface. Further, although not shown in FIG. 4, the common electrode and the alignment film are disposed over the color filters 20. In this arrangement, the portions of the lens member 34 which fill in the concave portions function as convex lenses 38 with respect to light entering into the lens member 34 from the liquid crystal layer via the alignment film, common electrode, and the color filters 20. In the example shown in FIGS. 3 and 4, one convex lens 38 is formed corresponding to each pixel 36.

The lens member 34 is formed having a predetermined thickness so as to provide a certain distance from the liquid crystal side surface of the second substrate 14 to the light-shielding layer 24 and the color filters 20. More specifically, the thickness of the lens member 34 is configured such that the optical length from the planar surface of the lens member 34 to the interface between the lens member 34 and the substrate 14 corresponds to an optical length required for sufficient exertion of the lens function by the lens member 34 and the substrate 14. The lens function is to reduce the light-shielding region having the light-shielding layer 24 formed therein and to enlarge the display region capable of display.

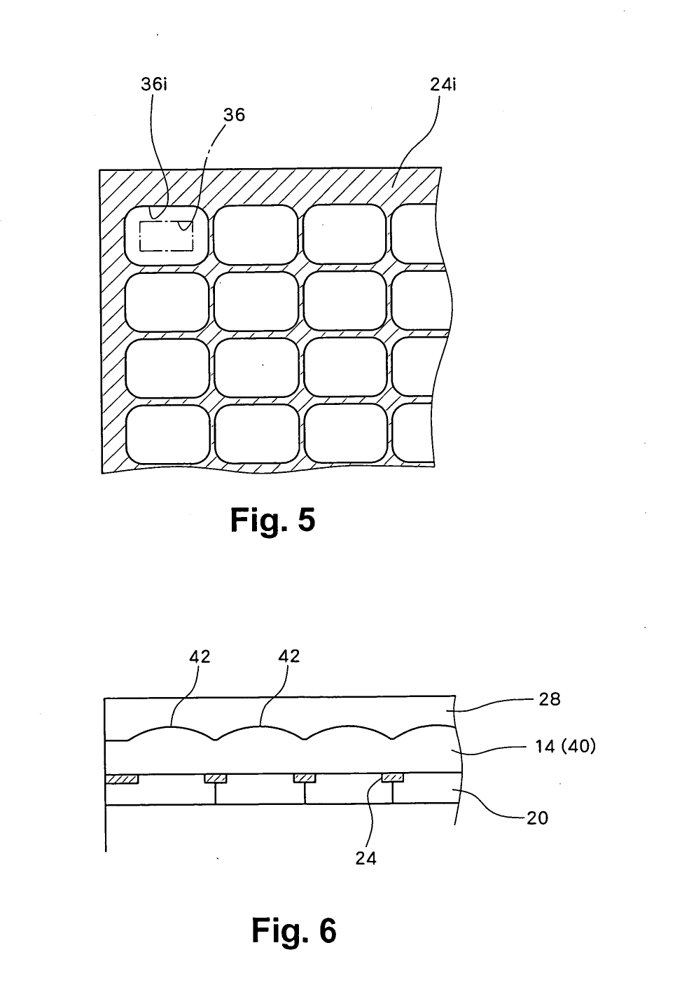

As shown in FIG. 4, each convex lens 38 magnifies the light flux obtained from the display region of a corresponding pixel, thereby serving to relatively reduce the formation region of the light-shielding layer 24 (the light-shielding region, or non-display region). Accordingly, the image that is actually observed by an observer is as shown in FIG. 5, wherein the virtual image pixel 36v appears larger than the original pixel depicted by a single-dot broken line, while the virtual image light-shielding region 24v appears narrower in contrast. As a result, the light-shielding region formed with the light-shielding layer 24 becomes less noticeable, achieving reduction or elimination of roughness in displayed images.

FIG. 6 shows another example of the lens structure. The lens structure 40 is provided as a shape pattern formed on the viewing side surface of the second substrate 14. In other words, convex lenses 42 are formed on the viewing side surface of the second substrate 14. The convex shape pattern can be obtained by etching the glass which constitutes the second substrate 14. Alternatively, the convex lenses may be formed on the planar surface of the second substrate 14 using an organic resin material such as the above-noted acrylic resin. It should be noted that, similarly to as in FIG. 1, the polarization plate 28 is provided on the viewing side surface of the second substrate 14. When the polarization plate 28 can be reliably adhered closely along the uneven (concave and convex) shape pattern of the viewing side surface of the second substrate 14 by means of an adhesive having a refractive index smaller than that of glass, the polarization plate 28 is directly attached to the surface on which the uneven shape pattern is formed using the adhesive. On the other hand, when it is not possible to sufficiently adhere the polarization plate 28 along the uneven surface by means of the above-noted adhesive alone, acrylic resin having a refraction index smaller than that of the glass substrate may be formed on the viewing side surface of the substrate 14 so as to fill in and planarize the unevenness, and then the polarization plate 28 may be adhered on the planarized surface.

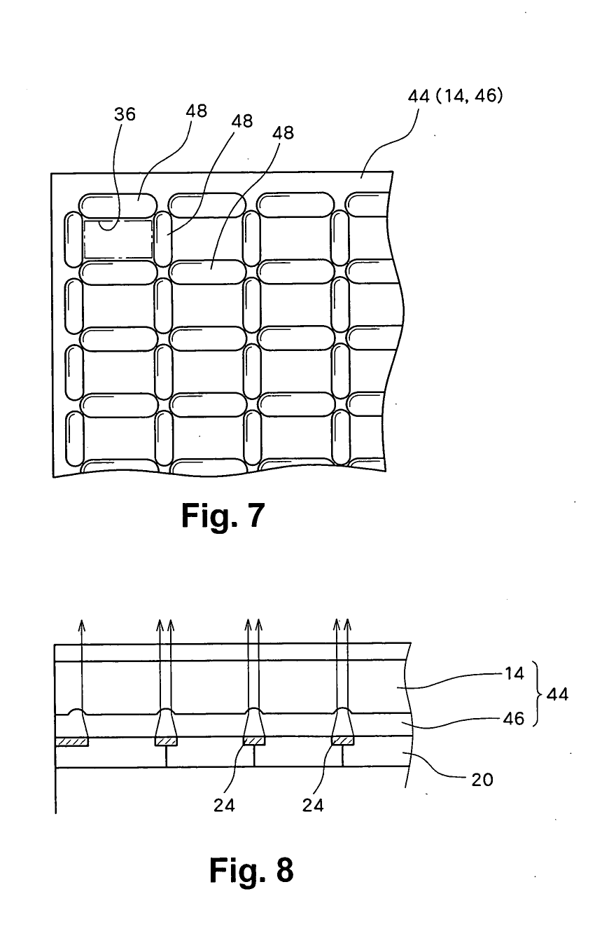

FIGS. 7 and 8 illustrate another embodiment of the present invention. The lens structure 44 according to this embodiment includes a second substrate 14 having concave portions formed in the light-shielding regions of the liquid crystal side surface, and a lens member 46 composed of a transparent material having a refraction index smaller than that of glass, which may, for example, be an acrylic organic material. The liquid crystal side surface of the second substrate 14 is etched in positions corresponding to the light-shielding regions (light-shielding layer 24) so as to form the concave portions. Subsequently, the lens member 46 is formed filling in the concave portions. The concave portions formed in the second substrate 14 function as cylindrical concave lenses 48 which are arranged opposing the light-shielding layer 24. The presence of the concave lenses 48 similarly serves to allow the width of the light-shielding region formed by the light-shielding layer 24 to appear narrower than the actual width, as shown in FIG. 5.

Alternatively, the lens structure 44 may be obtained by machining the viewing side surface of the second substrate 14 so as to form concave lenses. More specifically, the viewing side surface of the second substrate 14 may be etched to selectively form convex portions in positions corresponding to the light-shielding regions. In this case, because the liquid crystal side surface of the second substrate 14 is planar, the lens member 46 of FIG. 8 is unnecessary.

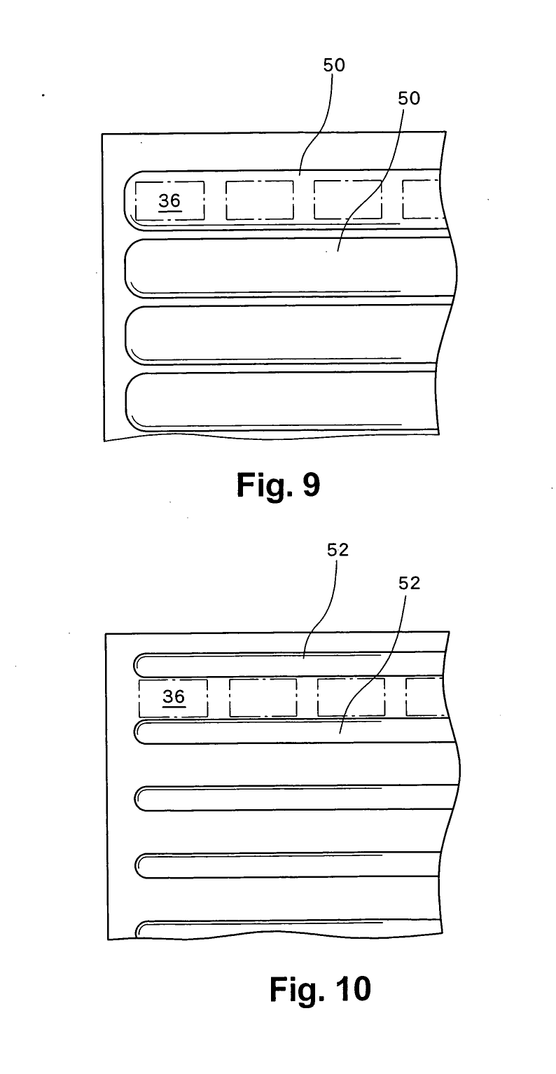

FIG. 9 shows a further embodiment of the lens structure. This lens structure does not include an individual lens for each pixel, but includes cylindrical convex lenses 50 each positioned opposing and provided commonly for a plurality of pixels 36 arranged along the horizontal scan direction (lateral direction in the drawings; hereinafter simply referred to as the “horizontal direction”) of the display panel. Similarly to the lens structure shown in FIGS. 3 and 4, the cylindrical convex lenses 50 can be formed by etching the liquid crystal side surface of the second substrate 14, and combining a lens member composed of an organic material having a refraction index greater than that of glass. Alternatively, as shown in FIG. 6, etching processing may be performed on the viewing side surface of the second substrate 14, such that cylindrical convex lenses positioned corresponding to pixel regions arranged along the horizontal direction are formed in the surface.

In a display panel, gaps between pixels in the horizontal direction are designed to have the narrowest possible widths, because large gaps in the horizontal direction would undesirably be noticeable and degrade display quality. At the same time, in the case of an active matrix type LCD in which a thin film transistor (TFT) is employed for each pixel, it is necessary to place, within one pixel region, elements such as the TFT and a storage capacitor for retaining data to be displayed in each pixel. Because these circuit elements must be connected to wiring, in many cases, the circuit elements are positioned by designing gaps (light-shielding regions) between pixels in the vertical scan direction (hereinafter simply referred to as the “vertical direction”) to be wider than the gaps in the horizontal direction. Accordingly, in the matrix-patterned light-shielding layer 24 for shielding light in the gaps between a plurality of pixels, the horizontal lines of the matrix pattern are typically formed wider than the vertical lines of the matrix, such that the light-shielding regions extending along the horizontal direction become more noticeable compared to the light-shielding regions extending along the vertical direction. Therefore, if the measure for reducing the adverse effects of the light-shielding regions is to be effected with respect to either one of the horizontal and vertical scan directions, a more effective performance can be attained by effecting the measure with respect to the light-shielding regions extending along the horizontal direction. For this reason, according to the present embodiment, the cylindrical convex lenses are formed extending in the horizontal direction along the display regions of the pixels.

By providing the cylindrical convex lenses 50, the pixels 36 appear enlarged in the vertical direction, such that the widths of the light-shielding regions located in positions of the gaps between pixels in the vertical direction and extending along the horizontal direction are perceived as correspondingly narrower than the actual widths. As a result, roughness in the displayed image can be reduced.

FIG. 10 shows a still further embodiment of the lens structure. This lens structure functions to allow the light-shielding regions formed by the horizontally-extending light-shielding layer 24 to appear narrower, similarly to the lens structure of FIG. 9. However, the lens structure of FIG. 10 differs from that of FIG. 9 in that cylindrical concave lenses 52 are provided in positions corresponding to the light-shielding regions extending along the horizontal direction. In a manner similar to the structure shown in FIGS. 7 and 8, the concave lenses 52 may be provided by etching the liquid crystal side surface of the second substrate 14, and forming on the etched surface a lens member composed of an organic material having a refraction index greater than that of glass. Alternatively, as shown in FIG. 6, the concave lenses 52 may be formed by performing etching processing on the viewing side surface of the second substrate 14. According to the present embodiment, the width (in the vertical direction) of the horizontally-extending light-shielding layer 24 is made to appear narrower (reduced in size), thereby reducing roughness in displayed images. It should be noted that by providing the cylindrical concave lenses 52 in positions corresponding to the horizontally-extending light-shielding regions as shown in FIG. 10 while also providing the cylindrical convex lenses 50 in positions corresponding to the display regions of the pixels arranged in horizontal arrays as shown in FIG. 9, enlarged display of the pixel regions along the horizontal direction and reduced display of the light-shielding regions extending in the horizontal direction can be accomplished in a further ensured manner.

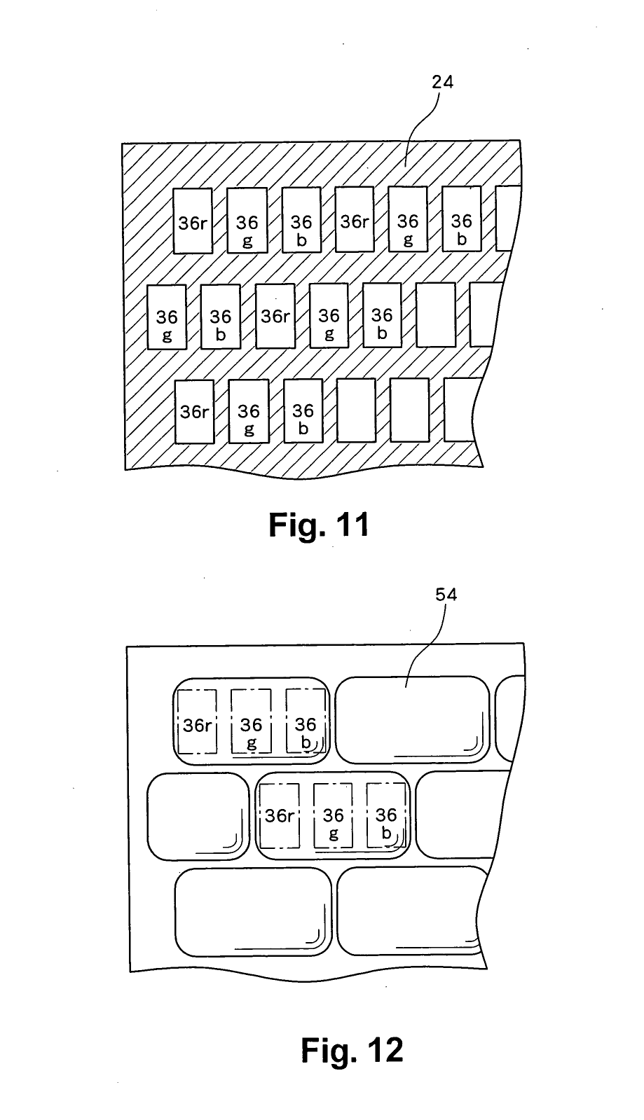

FIG. 11 shows an example of a display device having a delta arrangement in which adjacent pixel rows are shifted from one another by half a pitch. The pixels 36 for red, green, and blue are labeled with subscripts r, g, and b, respectively. FIG. 12 shows an embodiment of the lens structure adapted for a display device having a delta arrangement as shown in FIG. 11. As can be seen in FIG. 12, one convex lens 54 is provided corresponding to each pixel in terms of display control (that is, each color display unit) composed of three pixels of red, green, and blue. Similarly to as in FIGS. 3 and 4, the lenses may be formed on the liquid crystal layer 16 side surface of the second substrate 14, or alternatively, on the viewing side surface. Further, almost equivalent effects can be attained by providing concave lenses in positions corresponding to the light-shielding regions surrounding each color display unit.

When a delta arrangement is employed, the horizontally-extending light-shielding regions are formed wider than the vertically-extending light-shielding regions, similarly to as in the above-described case. Accordingly, as in the embodiment shown in FIGS. 9 and 10, a more effective performance in making the light-shielding regions to appear narrower can be attained by providing lenses along the horizontal direction compared to when providing lenses along the vertical direction. As such, cylindrical convex and concave lenses may be provided as shown in FIGS. 9 and 10 when a delta arrangement is employed.

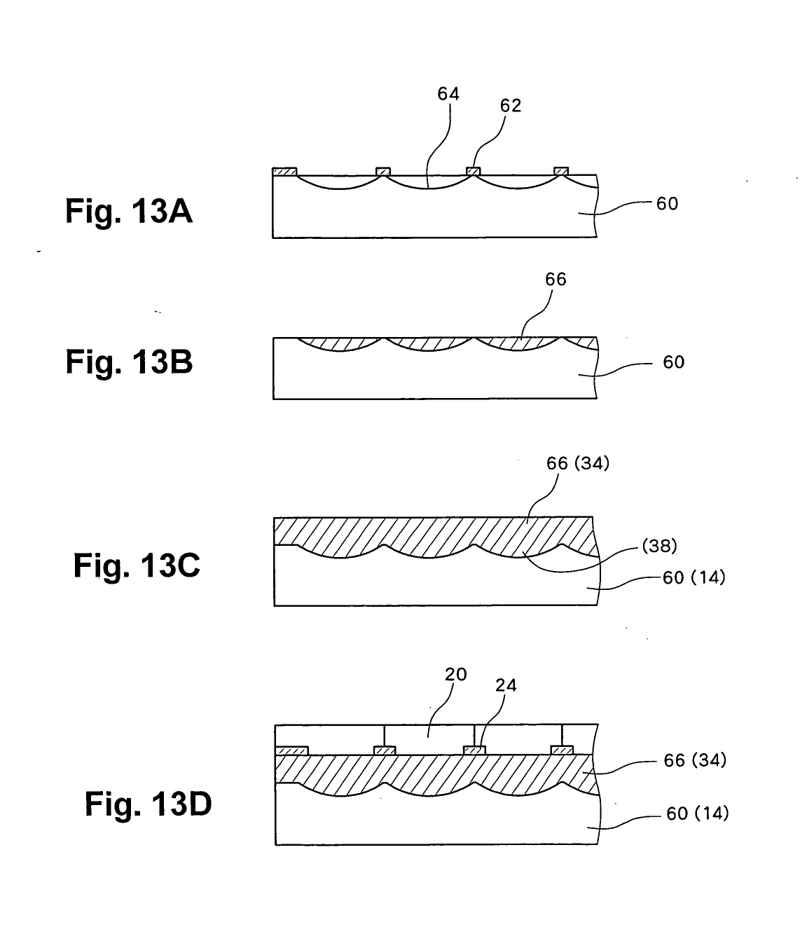

FIGS. 13A-13D illustrate steps for manufacturing the second substrate 14 including the lens structure. First, a mask 62 is formed on a glass substrate 60, and etching is performed so as to create concave portions 64 (FIG. 13A). Subsequently, anorganic material 66 (such as the above-noted acrylic resin) having a refractive index (approximately 1.6) which is greater than that of glass (approximately 1.52) is deposited on the surface having the concave portions 64, so as to fill in the concave portions 64 (FIG. 13B). Further on top, the surface of the substrate 14 is coated with the same organic material 66 as the organic material filling in the concave portions 64, thereby forming a layer of the organic material 66 having a predetermined thickness (FIG. 13C). This organic material 66 layer serves as the lens member 34 in FIG. 4, for example. In this example, the structures formed by filling in the concave portions 64 created on the glass substrate function as the convex lenses 38, and the glass substrate 60 is employed as the second substrate 14. In the lens member 34, the surface opposite from the side provided with the convex portions is planar. On this planar surface, the light-shielding layer 24 having the pattern according to the light-shielding regions, the color filters 20, the common transparent electrode 22, and the alignment film (not shown) are further formed so as to complete the viewing side substrate (FIG. 13D).

According to the above-described manufacturing method, because the convex lenses 38 and the light-shielding layer 24 are formed on the same side surface of the glass substrate 60, a higher precision in positional alignment can be achieved compared to when employing a method in which the viewing side surface of the glass substrate is etched and the light-shielding layer 24 and the like are formed on the liquid crystal layer side surface.

According to the above-described embodiments, the apparent aperture ratio can be enhanced while reducing roughness in images, making it possible to improve display quality.

While the lens structures in the above embodiments are described as being arranged according to the pattern of the light-shielding layer 24 formed on the second substrate 14 side, it is more preferable to arrange the lens structure not only according to the pattern of the light-shielding layer 24 on the second substrate 14 side but also according to the pattern of the light-shielding regions in the overall display panel. For example, there are cases in which a light-shielding layer is formed not only on the second substrate 14 side, but also on the first substrate side. In such a case, it is more preferable to take into account the pattern of the light-shielding layer on the first substrate side, because the light-shielding layer on the first substrate side shields light from the display light source (particularly the backlight arranged on the rear side of the panel) of the LCD and appears as light-shielding regions.

When the light-shielding layer is formed only on the first substrate 12 side, the lens structure can be provided according to the pattern of this light-shielding layer. In this case, the lens structure is preferably provided on the viewing side substrate, similarly to the above.

In the case of a passive matrix type LCD in which stripe patterns of electrodes extending in the horizontal direction are formed on one substrate while stripe patterns of electrodes extending in a direction orthogonal to the electrodes of the first substrate are formed on the other substrate, a horizontally-extending light-shielding layer and a vertically-extending light-shielding layer may be formed separately on the respective substrates corresponding to the extending directions of the electrodes. In this case too, as in other cases, the lens structure is preferably provided on the viewing side substrate.

Further, while the display device configuration in which color filters are arranged on the second substrate 14 are described above, the advantages of the lens structure of the present invention can be equivalently attained in a configuration in which color filters are arranged on the first substrate 12.

What is claimed is:

1. A liquid crystal display device in which liquid crystal is sealed between two substrates, wherein
a lens structure is provided on a side of a viewing side substrate, among the two substrates, in a position corresponding to each pixel or a pixel group including a plurality of pixels, and the lens structure serves to enlarge and display a display region of the pixel or the pixel group.

2. A liquid crystal display device as defined in claim 1, wherein
the pixel group comprises a plurality of pixels arranged along a horizontal scan direction of the liquid crystal display device.

3. A liquid crystal display device as defined in claim 1, wherein
the lens structure is a convex lens and is provided corresponding to the display region within each pixel or the pixel group.

4. A liquid crystal display device as defined in claim 1, wherein
the lens structure is formed by selectively etching a liquid crystal side surface of the viewing side substrate so as to create a concave surface, and by coating the concave surface with a layer having a refractive index different from that of the substrate.

5. A liquid crystal display device as defined in claim 1, wherein
the lens structure is composed of a convex surface formed by selectively etching a viewing side surface of the viewing side substrate.

6. A liquid crystal display device as defined in claim 1, wherein
the lens structure serves to reduce and display a light-shielding region formed at a gap between pixels.

7. A liquid crystal display device as defined in claim 6, wherein
the lens structure served to reduce the light-shielding region is formed by selectively etching the liquid crystal side surface of the viewing side substrate so as to create a convex surface, and by coating the convex surface with a layer having a refractive index different from that of the substrate.

8. A liquid crystal display device as defined in claim 6, wherein
the lens structure is composed of a concave surface formed by selectively etching a viewing side surface of the viewing side substrate.

9. A liquid crystal display device in which liquid crystal is sealed between two substrates, wherein
a lens structure is provided on a side of a viewing side substrate, among the two substrates, in a position corresponding to a light-shielding region formed at a gap between adjacent pixels, and the lens structure serves to reduce the light-shielding region.

10. A liquid crystal display device as defined in claim 9, wherein
the lens structure is arranged corresponding to at least the light-shielding region extending along a horizontal scan direction.

11. A liquid crystal display device as defined in claim 9, wherein
the lens structure provided corresponding to the light-shielding region is a concave lens.

12. A liquid crystal display device as defined in claim 9, wherein
the lens structure is formed by selectively etching the liquid crystal side surface of the viewing side substrate so as to create a convex surface, and by coating the convex surface with a layer having a refractive index different from that of the substrate.

13. A liquid crystal display device as defined in claim 9, wherein
the lens structure is composed of a convex surface formed by selectively etching a viewing side surface of the viewing side substrate.
